(19) United States
(12) Patent Application Publication
(10) Pub. No.: US 2025/0356415 A1
(43) Pub. Date: Nov. 20, 2025

(54) MODELING IMPROVEMENTS FOR COMPLEX DATA VERIFICATION

(71) Applicant: VeriFast, Inc., Belleville (CA)

(72) Inventors: Craig Schoen, North Bay (CA); Timothy Edward Ray, Etobicoke (CA)

(21) Appl. No.: 18/666,628

(22) Filed: May 16, 2024

(51) Int. Cl. G06Q 40/03

(52) U.S. Cl. CPC G06Q 40/03

(57) ABSTRACT

An example method includes receiving first data representing financial information associated with a user and identifying one or more information types associated with the financial information. The method also includes verifying the financial information using a first model configured to verify information, and applying one or more transformations to the first data to generate second data, wherein the second data includes at least a portion of the financial information and indicates an individual information type from the one or more information types. The method further includes storing the second data, wherein the second data is associated with a digital user passport and indicates that the financial information has been verified, receiving a request for the individual information type, and generating, based at least in part on the request and a second model configured to associated requests with financial information, a representation of the second data.

When an applicant applies for a lease agreement, a loan, or other type of contractual agreement, the applicant is typically required to provide documentation verifying various items of information. Gathering and providing the required documentation can be a burdensome task for the applicant, especially in instances where the applicant desires to submit multiple applications to different entities. At the same time, reviewers of such applications may need to review copious amounts of information from various documents and sources to make an informed decision regarding an application. However, reviewers may be unable to verify whether the information provided by the applicant is valid, up to date, or otherwise accurately reflects information associated with the applicant.

Conventional application services often require applicants to gather and provide appropriate physical or electronic documentation and are unable to verify such information as being authentic and ensure such documentation is not altered or fabricated. Furthermore, such conventional services typically rely on manual review of an application by a reviewer which may require hours of formatting, description from an applicant associated with various documents or contents thereof, calculations, and analysis.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to verify user information and generate a digital passport for an application, according to at least some examples.

FIG. 2 illustrates example components of the system of FIG. 1 that verifies user information and generates a digital passport for an application, according to at least some examples.

FIG. 3 depicts an example user interface that is usable to provide verified information for an application, according to at least some examples.

FIG. 4 illustrates an example user interface that is usable to provide verified information for an application, as well as a decision matrix for deciding whether to approve an application, in accordance with an example of the present disclosure.

FIG. 5 illustrates a flow diagram of an example process for the generation of a machine-learning model and the use of the same, according to at least some examples.

FIG. 6 illustrates a flowchart outlining an example method for verifying user information and generating a digital passport for an application, according to at least some examples.

### DETAILED DESCRIPTION

This application describes systems and techniques for verifying information associated with a user and generating a digital “passport” (e.g., wallet, portfolio, etc.) via a verification and decision system and/or service (hereinafter “data verification system”). A data verification system may receive financial data that has been provided by and/or received from a user (e.g., identification information, employment information, background information, income, debt, credit score, W-2 form, lease agreement, bank statement, and the like). The data verification system may be configured to preprocess the financial data in order to identify the type (i.e., category) of financial information and validate the financial data. After the financial data has been verified, the data verification system may filter the financial data and associate the filtered financial data with a specific type of information (e.g., filtering the financial data to only include salary information, and associating the salary information with income). The filtered data and associated types of information may be stored by the data verification system and added to the user's digital passport. This way, the specific type of information may be requested (e.g., a request for monthly income) by the user or a third-party entity, and the digital passport indicating the verified and relevant financial data may be output.

Traditionally, as discussed above, when an applicant (i.e., user) applies for a lease agreement (such as for a rental property, vehicle, or other lease agreement), a loan (such as for a mortgage, vehicle, or other loan), or other type of contractual agreement, the applicant is typically required to gather and provide documentation to be submitted along with an application. Gathering and providing such documentation can be a burdensome task for the applicant. For example, the applicant may be required to retrieve information from various entities and to gather documentation related to income, expenses, credit, debt, employment, education, identification, background, or other information associated with the applicant. Retrieving and providing such documentation may be especially burdensome in instances where an applicant desires to submit multiple applications to various separate entities that may desire different types of information or various formats for the information. Furthermore, in some examples, the applicant may be required to provide credit information (such as a credit score) to be submitted with the application. However, requesting multiple credit scores may negatively impact a credit score associated with the applicant.

Conventional systems allow an applicant to upload such information and documentation to be submitted along with an application. However, in typical examples, individual entities may include a dedicated system associated with the entity requiring the applicant to set up an account with each entity and to upload the information and documentation for each dedicated system associated with an application that the applicant submits with the entity.

Furthermore, conventional systems often require manual review of applications and the information and documents associated therewith. As such, reviewers of such applications may be required to review copious amounts of information from various document and sources to make an informed decision regarding the application. Still further, conventional systems may lack the ability to verify information and documents received in association with the application are authentic and free from alteration and/or have not been fabricated. Thus, reviewers may be unable to verify whether the information and documents provided by the applicant is valid, up to date, or otherwise accurately reflects information associated with the applicant.

Described herein are, at least in part, techniques including the verifying and filtering of financial data and generation of a representation of the financial data, such as a digital passport, such that the financial data may be shared. The techniques described herein may be applicable in various scenarios, including scenarios where a user would like to share financial information, or a third-party would like to receive financial information, in order to engage in a transaction (e.g., lease, loan, contract, etc.). Various examples of the present disclosure include systems, methods, and non-transitory computer-readable media of a data verification system.

A user of a data verification system may have financial data that may be used in a transaction, such as applying for a lease, loan, or other type of contractual agreement. Such financial data may also represent the user's identification information (i.e., a government-issued ID), employment information, background information, etc. The data verification system may be associated with a third-party entity (e.g., a landlord, creditor, employer, etc.) and may enable the user and/or the third-party entity to request that the financial data be shared. The data verification system may enable the user to share financial data via an application installed on a user device and/or via a web-based application accessed via a web browser. For example, the data verification system may enable the user to upload image data associated with a financial document (e.g., driver's license, passport, bank statement, employment contract, lease agreement, etc.) via the application or the web-based application. Additionally, or alternatively, the data verification system may enable the user to complete a form to provide financial data via the application or the web-based application.

Once the data verification system has received the financial data from the user, the data verification system may identify the type, or category, of information included in the financial data (e.g., income, identification, expenses, debt, etc.) and verify the information. In some examples, such as when the user has uploaded image data associated with a financial document, the data verification system may be configured to verify the financial document by identifying characteristics associated with such documents (i.e., serial numbers, water marks, etc.). Additionally, or alternatively, the data verification system may send a prompt to the user to request access to financial information from a third-party service that may provide at least a portion of the financial information to the data verification system. For example, the data verification system may send a prompt to the user to authorize access to the financial data by an open banking system, payroll data associated with an employer of the user, background check to be conducted via a background check service, credit check to be conducted via a credit check service, among other potential authorizations for third-party services.

The data verification system may verify information received directly from the user and/or from the third-party services. For example, the data verification system may determine that a name of the user is consistent between the identification received from the user and the financial information received from the open banking system. Additionally, or alternatively, the data verification system may also confirm that information is consistent with respect to current or past address(es), personal identification number(s), employment history, financial account information, debt information, etc. As such, the data verification system may cross-check information across various sources to determine whether such information is consistent or not and may determine whether to verify such information based on the consistencies or lack thereof.

In some instances, after the financial data from the user is validated, the data verification system may be configured to filter, or transform, the financial data and associate the filtered data with the respective type of financial information. For example, the user may provide a document to the data verification system that includes various different types of information (e.g., a W-2 form may include identifying information such as SSN as well as income information). Additionally, or alternatively, the financial data may include information that is not relevant to transactions involving the user and a third-party entity (e.g., it is not required for a lender, in deciding whether to grant a loan, to know that the user has green eyes). As such, the data verification system may “filter out” such information. In this way, the data verification system may generate filtered financial data that may be associated with a specific type and/or category of financial information. The filtered financial data may then be stored as a digital passport or other type of representation that indicates that the user's financial information has been validated.

After the filtered and verified financial data has been associated with, or added to, the user's digital passport, the passport may be used to easily disseminate the user's verified financial information to third-party entities. Third-party entities may request some, or all, of the user's financial data. When the data verification system receives a request from a third-party entity for the financial data of the user, the request may include a request for one or more individual types of information (e.g., a request for verified income, a request for verified identification, a request for verified employment history, etc.). The data verification system may be configured to identify, or match, the one or more individual types of financial information included in the request with the filtered financial data included in the digital passport that has been associated with at least one type of financial information. Accordingly, the data verification system may provide to the third-party entity the filtered financial data that has been matched to the one or more individual types of financial information included in the request. The matched financial data may be provided to the third-party entity by sharing a portion of and/or all of the digital passport. The digital passport that is shared with the third-party entity may include actual financial data (e.g., values associated with monthly income, DOB, list of employers, etc.) and/or include an indication that the information has been verified. As described in more detail below, the digital passport that is shared with the third-party entity may include an indication that the information has been verified as well as a “score” associated with the user based on the data included in the user digital passport.

Additionally, or alternatively, the user may request that their digital passport be shared with a third-party entity in order to share their financial data. For example, the user may be in the process of applying for a mortgage, and may request that their digital passport be shared with a mortgage lender. In some instances, when financial data that is included in a user's digital passport is requested to be shared by the user and/or a third-party entity, the data verification system may allow the user to select which portion(s) of the financial data is to be shared and/or a duration of time to share such information. For example, when a third-party entity requests all types of financial data, there may be some information that may be considered sensitive and/or not necessary for the third-party entity to obtain. As such, the data verification system may allow a user to provide verified financial information and financial insight with third-party entities in a simple and secure solution without requiring the user to gather and provide such information each time the user submits an application or otherwise provides such information.

In some instances, the data verification system may allow a user to send a digital passport that indicates that their financial data has been verified and/or provide a financial report and/or score without requiring sensitive information to be sent to an entity. For example, once an identity of the user has been verified, the user may send an indication to a third-party entity that the identity of the user has been verified, but may choose to restrict access to personal and/or or sensitive information associated with the user (such as a SSN, DOB, or other information). As such, the third-party entity receives an indication that the identity of the user is verified, while such personal and/or sensitive information is kept private by the user. Similarly, the user may choose to share a score associated with financial data of the user while choosing to restrict access to financial data associated with income, expenses, or other financial data. As such, the third-party entity may receive an indication from the data verification system that the user has a score that satisfies one or more score thresholds, while keeping at least portion of the financial data of the user private. It is to be understood that the user is provided with complete control over which information is shared and which information the user desires to keep private. The user may also have complete control over permissions associated with the information that is shared with the third-party entity. Furthermore, the third-party entity may be provided with various controls for requesting which financial data the third-party entity requires in order to be able to engage in a transaction with the user. The third-party entity may also be provided with various controls specifying a length of time for which a unique verification session is valid.

The data verification system may also include a score associated with the user based on the data included in the user digital passport. For example, the data verification system may determine an income score, an expense (or expenditure) score, and a composite score that is a sum of the income score and the expense score. In some examples, the data verification system may determine fewer scores or more scores than the scores described previously. Furthermore, the data verification system may determine one or more factors including financial factors, verification factors, or other factors associated with the information. The data verification system may determine one or more weighting factors for the one or more factors and may determine the one or more scores based on the one or more factors and the one or more weighting factors. For example, if the data verification system is unable to verify particular information associated with the user, the data verification system may assign a lower weighting factor to such information in order to reduce the impact of unverified information on the score. Conversely, the data verification system may weigh verified information higher in order to increase the impact of verified information on the score.

Still further, the one or more weighting factors may represent a relative impact that individual factors have on income, expenditure, stability, and/or consistency of financial data associated with the user. In some examples, the one or more weighting factors may be set by an entity (or user associated therewith) or the one or more weighting factors may be determined by a machine learning model configured to determine the score associated with the user. The machine learning model may be trained by determining one or more financial factors and/or one or more weighting factors associated with financial data across a plurality of user over time. Furthermore, in some examples, the machine learning model may be configured to automatically recognize and/or identify income sources (such as payroll, government income, alternative income, etc.) by identifying patterns of credit deposits or other sources of alternative income that may not be included in conventional income statements or may not be easily recognized by a reviewer. As such, the data verification system may identify all recurring income sources based at least in part on the financial data. Furthermore, in some examples, the data verification system may weight the income sources based on the type of income, reliability of the income, or based on other factors, as described herein. Additionally, or alternatively, the data verification system may recognize various sources of income and allow the reviewer to weight such sources of income.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

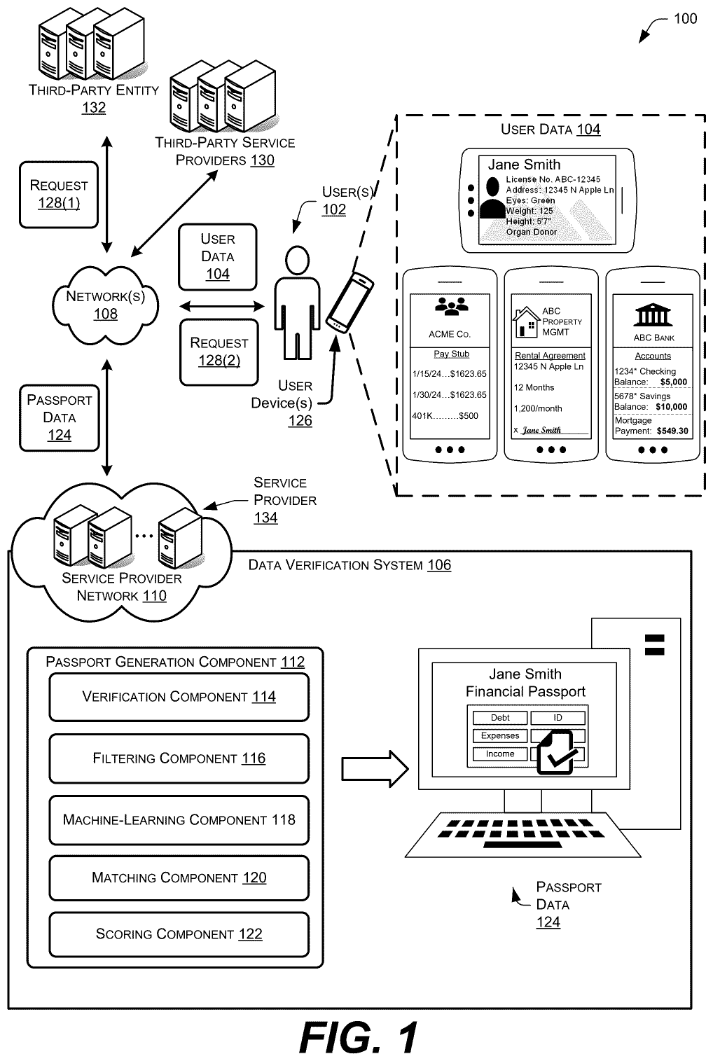

FIG. 1 is a schematic view of an example environment 100 in which a data verification system 106 at a service provider network 110 verifies user data 104 and generates passport data 124 for a digital passport to be shared by the user 102 and/or request by third-party entities 132.

In some examples, the service provider network 110 may be or comprise a cloud provider network. In other instances, however, the service provider network 110 may be an on-premises network, a private network of a corporation, and/or any other type of network or combination thereof. The data verification system 106 may be included in, or associated with, the service provider network 110. The verification service provider 134 may provide data verification services to user(s) 102 at user device(s) 126. User device(s) 126 may communicate with the verification service provider 134 over network(s) 108, such as Internet. In some instances, the network(s) 108 may generally comprise one or more networks implemented by any viable communication technology, such as wired and/or wireless modalities and/or technologies. The network(s) 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the user device(s) 126 and/or third-party entities may access the data verification system 106.

As illustrated, a user 102 may be associated with a user device 126 that enables the user 102 to share user data 104 with the verification service provider 134. In some examples, the user device(s) 126 may include desktop computers, laptop computers, tablet computers, mobile devices (e.g., smart phones or other cellular or mobile phones, mobile gaming devices, portable media devices, etc.), or other suitable computing devices. The user device(s) 126 may execute one or more client applications, such as a web browser (e.g., Microsoft Windows Internet Explorer, Mozilla Firefox, Apple Safari, Google Chrome, Opera, etc.) and/or a native or special-purpose client application (e.g., social media applications, messaging applications, email applications, games, etc.), to access and view content over the network 108.

In some instances, a user 102 of the verification service provider 134 may have user data 104 that may be used in a transaction with third-party entities 132 (e.g., lender, creditor, employer, etc.), such as applying for a lease, loan, or other type of contractual agreement. The user data 104 may also represent the user 102's identification information. The data verification system 106 may enable the user 102 to share user data 104 via an application installed on the user device 126 and/or via a web-based application accessed via a web browser. For example, the data verification system 106 may enable the user 102 to upload image data associated with a financial document (e.g., driver's license, passport, bank statement, employment contract, lease agreement, etc.) via the application or the web-based application. Additionally, or alternatively, the data verification system 106 may enable the user 102 to complete a form to provide the user data 104 via the application or the web-based application.

Once the data verification system 106 has received the user data 104 from the user 102, the data verification system 106 may include a passport generation component 112 and verification component 114 that is configured to preprocess the user data 104 and identify the type, or category, of information included in the user data 104 (e.g., income, identification, expenses, debt, etc.) and verify the information in order to generate passport data 124. The data verification system 106 may include one or more servers or other computing devices, any or all of which may include one or more processors and memory storing computer executable instructions to implement the functionality discussed herein attributable to the data verification system 106 or digital platform. The data verification system 106 may enable user(s) 102 and/or third-party entities 132 to interact with the data verification system 106.

In some examples, such as when the user 102 has uploaded image data associated with a financial document, where the user data 104 is included in the financial document, the data verification system 106 may be configured to verify the user data 104 via verification component 114 by identifying characteristics associated with such documents (i.e., serial numbers, water marks, etc.). In some examples, the verification component 114 may be associated with machine-learning components 118, and may use optical character recognition, computer vision, and the like in order to preprocess the financial document and/or verify the financial document, and in turn, verify the user data 104.

As used herein, the one or more processes performed by the data verification system 106 may include the use of machine-learning component 118. For example, the machine learning models as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Continuing from the example above, the user data 104 may be provided to the data verification system 106 as image data of a bank statement. The verification component 114 may be configured to preprocess the image data of the bank statement in order to verify the bank statement and user data 104 contained therein. For example, the verification component 114 may identify characteristics contained within the bank statement (e.g., a bank logo) in order to identify the type of document and/or type of financial information (e.g., bank statement, government-issued ID card, rental agreement, pay stub, etc.) Based on the type of document and/or type of financial information, the verification component 114 may verify the user data 104 contained within the document using the machine-learning component 118. For example, the machine-learning component 118 may include one or more models configured to verify certain types of documents and/or types of financial information.

In another example, the user 102 may provide user data 104 including identification information by uploading a photograph of their government-issued ID card. The verification component 114 may identify characteristics associated with the ID card (e.g., a mountain feature in the background of the ID card and license number) in order to verify the ID card as legitimate, and in turn verify the identifying user data 104. Additionally, or alternatively, the data verification system 106 may send a prompt to the user 102 to request access to user data 104 from a third-party service provider 130 that may provide at least a portion of the user data 104 to the data verification system 106. For example, the data verification system 106 may send a prompt to the user 102 to authorize access to the user data 104 by an open banking system, payroll data associated with an employer of the user 102, background check to be conducted via a background check service, credit check to be conducted via a credit check service, among other potential authorizations for third-party services. In some examples, the data verification system 106 may send a prompt to the user 102 to allow the user 102 to select a third-party service provider 130 that the user 102 may have an account associated with. For example, to access payroll data associated with an employer, the user 102 may log into a payroll service and may grant access to portion(s) of payroll data by the data verification system 106 via the payroll service.

The verification component 114 associated with the data verification system 106 may verify user data 104 received directly from the user 102 and/or from the third-party service providers 130. In some instances, when the verification component 114 determines that user data 104 is consistent, the verification component 114 may generate an indication that a portion of the user data 104 has been verified. However, if the verification component 114 determines that the user data 104 is inconsistent, the verification component 114 may generate an indication that a portion of the user data 104 is unverified or requires further review or further information to verify the portion of the user data 104. Furthermore, if the verification component 114 determines that user data 104 is missing or incomplete, the verification component 114 may generate an indication that the user data 104 is missing or incomplete and may send a request to the user 102 and/or the third-party service providers for additional information.

For example, the verification component 114 may determine that a name of the user 102 is consistent between an identification received from the user 102 and financial information received from third-party service providers 130, such as an open banking system. Additionally, or alternatively, the verification component 114 may also confirm that information is consistent with respect to current or past address(es), personal identification number(s), employment history, financial account information, debt information, etc. As such, the verification component 114 may cross-check user data 104 across various sources to determine whether such user data 104 is consistent or not and may determine whether to verify such user data 104 based on the consistencies or lack thereof.

In some instances, after the user data 104 from the user 102 is validated, the data verification system 106 may be configured to filter, or transform, the user data 104 and associate the filtered data with the respective type of financial information. For example, a filtering component 116 associated with the data verification system 106 may filter, or transform, the user data 104 and associate the filtered user data 104 with the respective type of financial information. For example, the user 102 may provide a document to the data verification system 106 that includes various different types of information (e.g., a W-2 form may include identifying information such as SSN as well as income information). Additionally, or alternatively, the user data 104 may include information that is not relevant to transactions involving the user 102 and a third-party entity 132 (e.g., it is not required for a lender, in deciding whether to grant a loan, to know that the user has green eyes as included in a government-issued ID). As such, the filtering component 116 of the data verification system 106 may “filter out” such information. In this way, the data verification system 106 may generate filtered user data 104 that may be associated with a specific type and/or category of financial information. In some examples, the filtered user data 104 that may be associated with a specific type and/or category of financial information may be determined by a machine-learning component 118 configured to filter and associate user data 104. The machine-learning component 118 may be trained by determining one or more filters and/or or more types of financial information associated with the user data 104 of a user 102 over time. Furthermore, in some examples, the machine-learning component 118 may be configured to automatically filter and/or associate user data 104 with types of financial information by identifying patterns that may not be included in conventional financial documents or may not be easily recognized by a third-party entity 132. The filtered user data 104 may then be stored as passport data 124 in a digital passport or other type of representation that indicates that the user data 104 has been verified.

After the user data 104 has been verified by the verification component 114 and/or filtered by the filtering component 116, and associated with, or added to, the user 102's digital passport as passport data 124, the passport data 124 may be used to easily disseminate the user 102's financial information to third-party entities 132. Third-party entities 132 may submit a request 128(1) for some, or all, of the user data 104. When the data verification system 106 receives the request 128(1) from a third-party entity 132 for the user data 104, the request 128(1) may include a request for one or more individual types of information (e.g., a request for verified income, a request for verified identification, a request for verified employment history, etc.). The data verification system 106 may be configured to identify, or match, the one or more individual types of financial information included in the request 128(1) with the passport data 124 included in the digital passport that has been associated with at least one type of financial information. For example, the data verification system 106 may be associated with a matching component 120 that is configured to match the request 128(1) with the appropriate passport data 124 that is responsive to the request 128(1). Accordingly, the data verification system 106 may provide to the third-party entity 132 the passport data 124 that has been matched to the one or more individual types of financial information included in the request 128(1). The matched passport data 124 may be provided to the third-party entity 132 by sharing a portion of and/or all of the digital passport. The passport data 124 that is shared with the third-party entity 132 may include actual user data 104 (e.g., values associated with monthly income, DOB, list of employers, etc.) and/or include an indication that the user data 104 has been verified. As described in more detail below, the passport data 124 that is shared with the third-party entity 132 may include an indication that the user data 104 has been verified as well as a “score” associated with the user 102 based on the user data 104.

The matching component 120 may leverage one or more machine-learning component(s) 118 of the passport generation component 112 to identify the appropriate passport data 124 to be shared in response to requests 128. For instance, the machine-learning component 118 may use a feature reduction and/or feature selection algorithm to identify one or more portions of the passport data 124 that respond to requests 128 the most. Additionally, or alternatively, the matching component 120 may input requests 128 into a deep neural network of the machine-learning component 118, where the deep neural network is trained to determine the appropriate portions of passport data 124 to be shared in response to the requests 128.

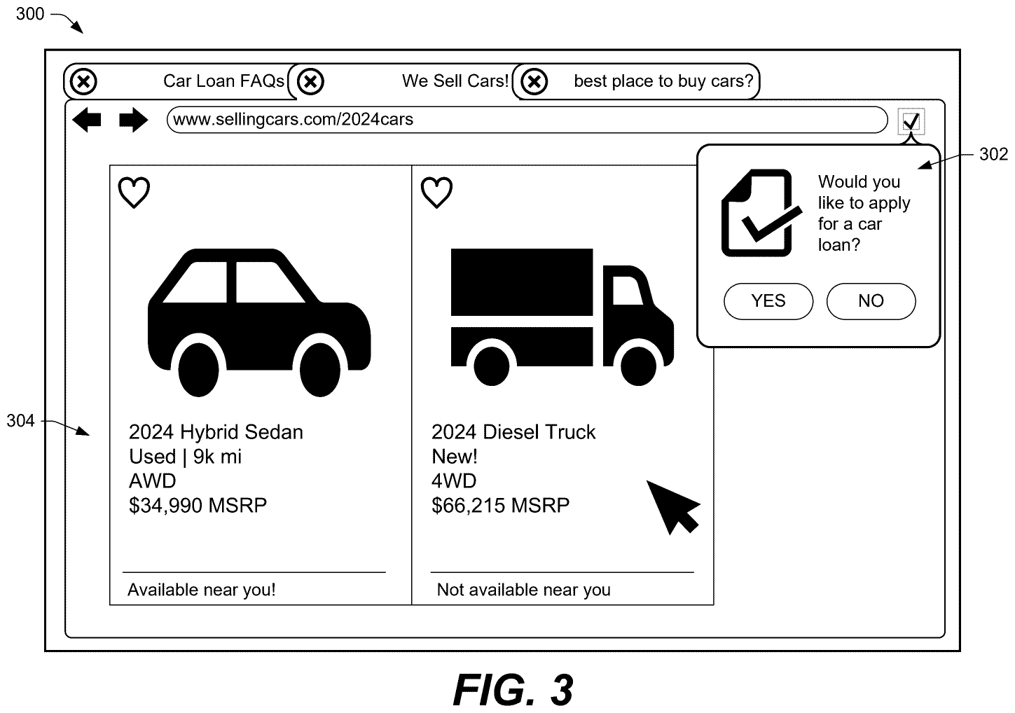

Additionally, or alternatively, the user 102 may submit a request 128(2) that their passport data 124 be shared with a third-party entity 132 in order to share their user data 104. For example, the user 102 may be in the process of applying for a mortgage, and may request that their passport data 124 be shared with a mortgage lender. As described in more detail below with respect to FIG. 3, request 128(2) may be associated with user account data, such as user browsing data, that is used to indicate a user 102's intent to share passport data 124. In some instances, when requests 128 by the user 102 and/or the third-party entity 132 to share the passport data 124 are received by the data verification system 106, the data verification system 106 may allow the user 102 to select which portion(s) of the passport data 124 is to be shared and/or a duration of time to share the passport data 124. For example, when a third-party entity 132 requests all types of user data 104, there may be some information that may be considered sensitive and/or not necessary for the third-party entity 132 to obtain. As such, the data verification system 106 may allow the user 102 to send passport data 124 that indicates that their user data 104 has been verified and/or provide a financial report and/or score without requiring sensitive information to be sent to the third-party entity 132. For example, once an identity of the user 102 has been verified, the user 102 may send, via the data verification system 106, passport data 124 including an indication to a third-party entity 132 that the identity of the user 102 has been verified, but may choose to restrict access to personal and/or or sensitive user data 104 (such as a SSN, DOB, or other information). As such, the third-party entity 132 receives passport data 124 including an indication that the identity of the user 102 is verified, while such personal and/or sensitive user data 104 is kept private by the user 102. Similarly, the user 102 may choose to share a score associated with user data 104 while choosing to restrict access to user data 104 associated with income, expenses, or other financial data. As such, the third-party entity 132 may receive an indication from the data verification system 106 that the user 102 has a score that satisfies one or more score thresholds, while keeping at least portion of the user data 104 private. It is to be understood that the user 102 is provided with complete control over which passport data 124 is shared and which passport data 124 the user 102 desires to keep private. The user 102 may also have complete control over permissions associated with the passport data 124 that is shared with the third-party entity. Furthermore, the third-party entity 132 may be provided with various controls for requesting which user data 104 the third-party entity 132 requires in order to be able to engage in a transaction with the user 102. The third-party entity 132 may also be provided with various controls specifying a length of time for which a unique verification session is valid.

As indicated above, the data verification system 106 may also be configured to include a score associated with the user 102 in the passport data 124. The data verification system 106 may be associated with a scoring component 122. For example, the scoring component 122 may determine an income score, an expense (or expenditure) score, and a composite score that is a sum of the income score and the expense score. In some examples, the scoring component 122 may determine fewer scores or more scores than the scores described previously. Furthermore, the scoring component 122 may determine one or more factors including financial factors, verification factors, or other factors associated with user data 104. The scoring component 122 may determine one or more weighting factors for the one or more factors and may determine the one or more scores based on the one or more factors and the one or more weighting factors. For example, if the verification component 114 is unable to verify particular user data 104 associated with the user 102, the scoring component 122 may assign a lower weighting factor to such user data 104 in order to reduce the impact of unverified information on the score. Conversely, the scoring component 122 may weigh verified information higher in order to increase the impact of verified information on the score.

Still further, the one or more weighting factors may represent a relative impact that individual factors have on income, expenditure, stability, and/or consistency of user data 104 associated with the user 102. In some examples, the one or more weighting factors may be set by a third-party entity 132 or the one or more weighting factors may be determined by a machine-learning component 118 configured to determine the score associated with the user 102. The machine-learning component 118 may be trained by determining one or more financial factors and/or one or more weighting factors associated with user data 104 across a plurality of users 102 over time. Furthermore, in some examples, the machine-learning component 118 may be configured to automatically recognize and/or identify income sources (such as payroll, government income, alternative income, etc.) by identifying patterns of credit deposits or other sources of alternative income that may not be included in conventional income statements or may not be easily recognized. As such, the scoring component 122 may identify all recurring income sources based at least in part on the user data 104. Furthermore, in some examples, the scoring component 122 may weigh the income sources based on the type of income, reliability of the income, or based on other factors, as described herein. Additionally, or alternatively, the scoring component 122 may recognize various sources of income and allow the third-party entity 132 to weigh such sources of income.

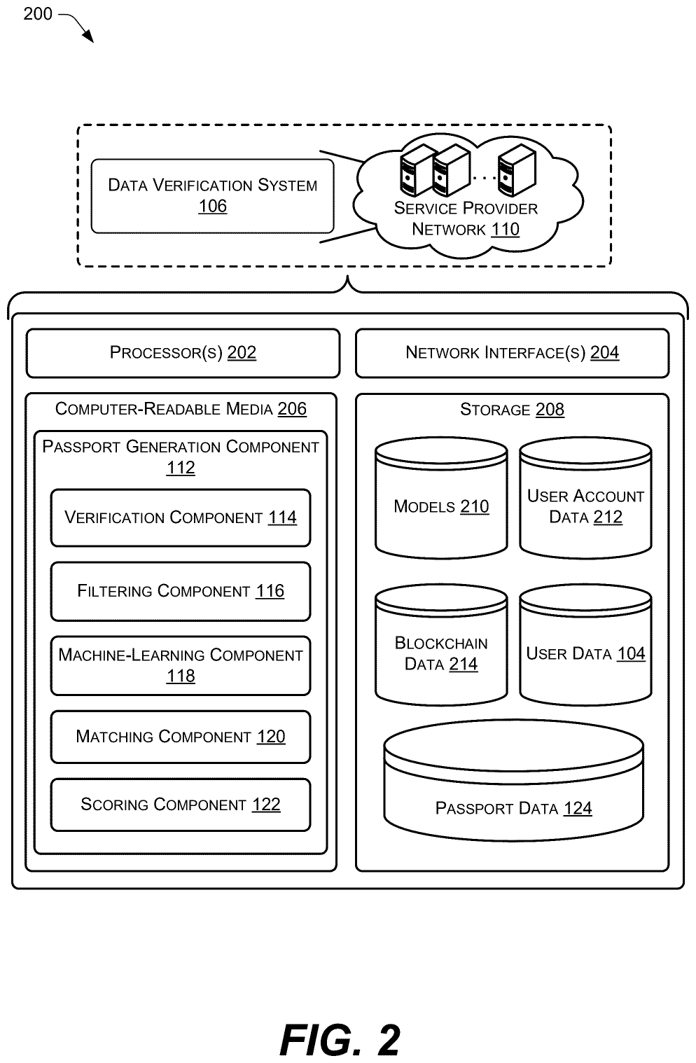

FIG. 2 illustrates an example environment 200 of example components of the data verification system 106 at the service provider network 110. As illustrated, the data verification system 106 may include one or more hardware processor(s) 202 (processors) configured to execute one or more stored instructions. The processors 202 may comprise one or more cores.

Further, the data verification system 106 may include network interface(s) 204 to allow the processor 202 or other portions of the service provider network 110 to communicate with other devices. The network interface(s) 204 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 may include devices configured to couple to personal area networks (PANs), wired and wireless local area networks (LANs), wired and wireless wide area networks (WANs), and so forth. For example, the network interface(s) 204 may include devices compatible with Ethernet, Wi-Fi™, and so forth. Network interfaces 204 are representative of functionality to allow a user to enter commands and information to the data verification system 106, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth.

The data verification system 106 may also include computer-readable media 206 that stores various executable components (e.g., software-based components, firmware-based components, etc.). In addition to various components discussed in FIG. 1, the computer-readable media 206 may further store components to implement functionality described herein. While not illustrated, the computer-readable media 206 may store one or more operating systems utilized to control the operation of the one or more devices that comprise the service provider network 110. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 206 may include a passport generation component 112 that configures the data verification system 106 to perform various operations described herein. For instance, the passport generation component 112 may be configured to, when executed by the processors 202, perform various techniques for verifying user information and generating a digital passport. For example, the passport generation component 112 may utilize data, such as user data 104, that may be used in a transaction with third-party entities 132 (e.g., lender, creditor, employer, etc.), such as applying for a lease, loan, or other type of contractual agreement.

The computer-readable media 206 may include a verification component 114 that configures the data verification system 106 to perform various operations described herein. For instance, the verification component 114 may be configured to, when executed by processors 202, perform various techniques for verifying user data 104. The verification component 114 may utilize user data 104 that is received directly from a user 102 and/or received from a third-party service provider 130. For example, the verification component 114 determine whether the user data 104 provided by the user 102 is consistent with user data 104 provided by the third-party service provider 130. If the verification component 114 determines there is a consistency between user data 104, the verification component may generate an indication that at least a portion of the user data 104 has been verified. Additionally, or alternatively, in instances where a user 102 has provided their user data 104 as image data associated with a financial document, the verification component 114 may be configured to verify the user data 104 by identifying characteristics associated with the financial document (i.e., serial numbers, water marks, etc.). The verification component 114 may determine if there is a consistency between the characteristics associated with the financial document containing user data 104, and other financial documents associated with third-party service providers 130. In some examples, the verification component 114 may be associated with one or more machine-learning components 118, and may use optical character recognition, computer vision, and the like in order to verify the financial document, and in turn, verify the user data 104.

The computer-readable media 206 may also include a filtering component 116 that configures the data verification system 106 to perform various operations described herein. The filtering component 116 may work in conjunction with the verification component 114 to generate passport data 124 to be included in a digital passport. For example, a filtering component 116 may filter, or transform, the user data 104 and associate the filtered user data 104 with the respective type of financial information. The filtered user data 104 may then be stored as passport data 124 in a digital passport or other type of representation that indicates that the user data 104 has been verified.

The computer-readable media 206 may also include a matching component 120 that is configured to match requests for user data 104 with the appropriate passport data 124 in a digital passport. The matching component 120 may leverage the machine-learning component 118 of the passport generation component 112 to identify the appropriate passport data 124 to be shared in response to requests 128. For instance, the machine-learning component 118 may use a feature reduction and/or feature selection algorithm to identify one or more portions of the passport data 124 that respond to requests 128 the most appropriately. Additionally, or alternatively, the matching component 120 may input requests 128 into a deep neural network of the machine-learning component 118, where the deep neural network is trained to determine the appropriate portions of passport data 124 to be shared in response to the requests 128. In some examples, the matching component 120 may be configured to match passport data 124 to user account data 212. The matching component 120 may extract user account data 212 that identifies a user browsing pattern indicating a context associated with the passport data 124. In this example, the matching component 120 may establish connections (e.g., application programming interface (API) calls with a browser application running on the user device(s) 126. The matching component 120 may expose the browser application interface, and in turn extract user account data 212 such as user browsing patterns. For example, a user browsing pattern may indicate a user 102's desire to purchase a car. In this way, the matching component 120 may leverage the machine-learning component 118 to identify the appropriate passport data 124 to be shared on behalf of the user 102. For instance, the machine-learning component 118 may use a feature reduction and/or feature selection algorithm to identify one or more portions of the passport data 124 that respond to a user browsing pattern the most appropriately. Additionally, or alternatively, the matching component 120 may input requests for user account data 212, such as the user browsing pattern, into a deep neural network of the machine-learning component 118, where the deep neural network is trained to determine the appropriate portions of passport data 124 to be shared in response to the user account data 212. Continuing from the example above, the matching component 120 may determine the appropriate portions of passport data 124 to be shared for a car loan application, and provide the user 102 with an indication to share such passport data 124.

The computer-readable media 206 may include a scoring component 122 that configures the data verification system 106 to perform various operations described herein. For instance, the scoring component 122 may be configured to, when executed by the processor 202, perform various techniques for determining user scores to be included in passport data 124 and provided to third-party entities 132. The scoring component 122 may use the user data 104 to determine an income score, an expense (or expenditure) score, and a composite score that is a sum of the income score and the expense score. Additionally, or alternatively, the scoring component 122 may determine one or more factors including financial factors, verification factors, or other factors associated with user data 104

Additionally, the data verification system 106 may include storage 208 which may comprise one, or multiple, repositories or other storage locations for persistently storing and managing collections of data such as databases, simple files, binary, and/or any other data. The storage 208 may include one or more storage locations that may be managed by one or more storage/database management systems. The storage 208 represents memory/storage capacity associated with one or more computer-readable media 206. The storage 208 may include volatile media (such as random access memory (RAM)) and/or nonvolatile media (such as read only memory (ROM), Flash memory, optical disks, magnetic disks, and so forth). The storage 208 may include fixed media (e.g., RAM, ROM, a fixed hard drive, and so on) as well as removable media (e.g., Flash memory, a removable hard drive, an optical disc, and so forth).

As illustrated, the storage 208 may include models 210, user account data 212, blockchain data 214, user data 104, and/or passport data 124. It should be appreciated that the foregoing list is merely exemplary and the storage 208 may include additional elements that may be apparent to one skilled in the art.

The models 210 may include a database of machine-learning models that are to be used by the machine-learning component 118. The user account data 212 may include a database of user browsing patterns associated with a user 102. The database may be formed as a historical compilation of user browsing patterns obtained by the matching component 120 and indicating a life-event associated with the user 102 (e.g., purchasing a car, applying for a job, refinancing a home, applying for a rental property, etc.).

The blockchain data 214 may include a database of private and/or public blockchains. Blockchain data 214 may function to record sender identifications, recipient identifications, public keys, timestamps at which user data 104 has been verified and/or passport data 124 created, a duration at which a user 102 has specified that passport data 124 may be shared, and the like.

The user data 104 may include a database of information that may be used in a transaction with third-party entities 132 (e.g., lender, creditor, employer, etc.), such as applying for a lease, loan, or other type of contractual agreement. The user data 104 may also represent the user 102's identification information. The passport data 124 may include a database of user data 104 that may be shared with third-party entities 132. For example, the passport data 124 may include user data 104 that has been verified and/or filtered. Additionally, or alternatively, the passport data 124 may include verified user data 104 that is appropriate for a request received by a third-party entity 132 and/or user 102. The passport data 124 may also include scored determined by scoring component 122.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

FIG. 3 depicts an example user interface 300 which may be displayed via user device(s) 126 in which the data verification system 106 receives and/or extracts user account data 212 for users 102, where passport data 124 may be shared based on the user account data 212.

In order to provide third-party entities 132 with passport data 124, the data verification system may obtain user account data 212, such as user browsing patterns 304. The user account data 212 may be extracted from one or more applications running on a user device 126 and/or may be received directly from a third-party service provider 130. In one example, the third-party service provider 130 may be an internet browsing service provider. Additionally, or alternatively, the data verification system 106 may establish connections (e.g., application programming interface (API) calls) with an internet browsing application running on the user device(s) 126. The data verification system 106 may expose an interface of an internet browsing application, where user account data 212 may include indications that the user 102 wishes to finance the purchase of a car and/or obtain a car loan (e.g., the user account data 212 may indicate a user browsing pattern 304 of car sale websites, searches about car loans, and the like).

Upon extracting and/or receiving the user browsing patterns 304, the matching component 120 may determine the appropriate passport data 124 to be shared with a third-party entity 132. Continuing from the example above, the matching component 120 may determine passport data 124 representing a verified credit score, verified identification, and the like may be necessary in applying for a car loan. As such, the data verification system 106 may provide the user 102 with a notification 302 via user interface 300 asking for user input in sharing the passport data 124. As illustrated in FIG. 3, the data verification system 106 may provide the user 102 with a notification 302 asking whether to apply for a car loan using the verified passport data 124 by simply selecting “yes” or “no.”

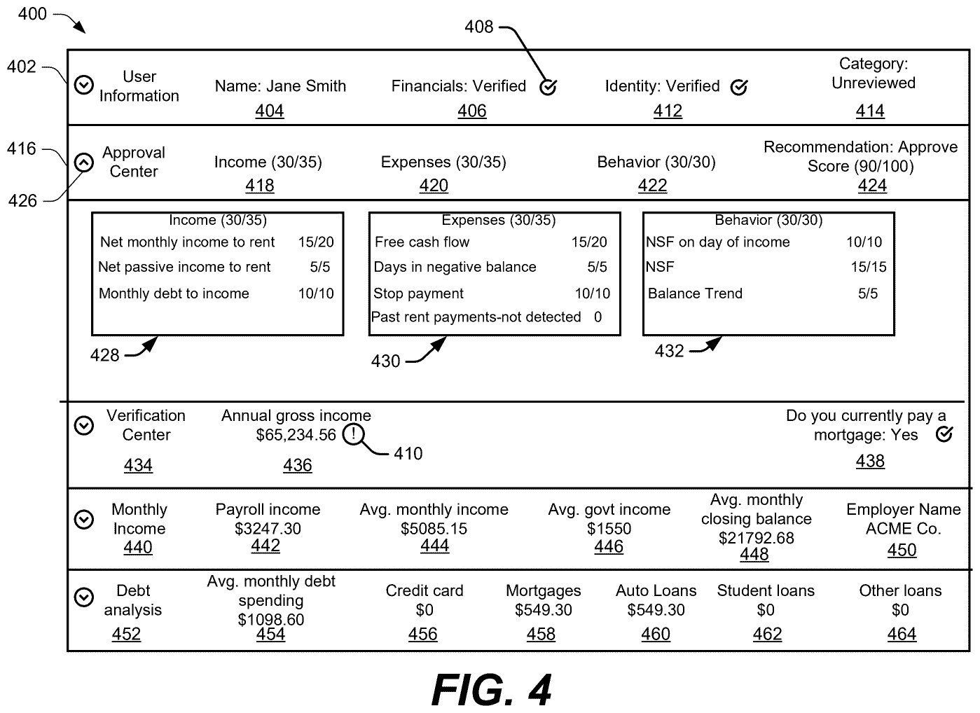

FIG. 4 depicts an example user interface 400 which may be displayed via user device(s) 126. Additionally, or alternative, the user interface 400 may be displayed via devices associated with third-party entities 132. The user interface 400 may be configured to provide verified information as well as a decision matrix associated with user data 104, and may be included in the user passport data 124. For example, the verified information as well as the decision matrix associated with the user data 104 may be used in connection to a transaction and/or application associated with the user 102 (e.g., application for employment, rental property, loan, etc.) where the user provides passport data 124. The user interface 400 may include detailed information, data, and analysis that is gathered and determined from the information provided by a first user 102 and/or received from the third-party service providers 130. In some examples, the user interface 400 may be provided to a third-party entity 132 to recommend or otherwise assist the third-party entity 132 to review the user data 104 associated with the first user 102. Furthermore, the user interface 400 may also be provided to the first user 102 to give the user detailed insight into their information and financial data as part of their passport data 124.

In some examples, the user interface 400 may include user information 402 associated with the user 102. In some examples, the user information 402 may include a name 404 (e.g., “Jane Smith”) of the user 102 or other identifying information associated with the user 102. In some examples, the user information 402 portion of the user interface 400 may also provide a summary of an application of the user 102. For example, the user interface 400 may provide an indication 406 indicating whether financial information associated with the user 102 has been verified. In some examples, when information associated with the user 102 has been verified, the user interface 400 may display the word “Verified” along with a verification icon 408 to indicate that such information has been verified. It is to be noted, that the verification icon 408 may be displayed in associated with any verified information that is provided via the user interface 400. In some examples, when the data verification system 106 is unable to verify information associated with the user 102, the user interface 400 may display an icon 410 indicating that the information requires further review and/or that the information includes inconsistencies. It is to be noted, that the icon 410 may be displayed in associated with any unverified information that is provided via the user interface 400. The user interface 400 may also provide an indication 412 indicating whether the identity of the user 102 has been verified.

The indications 406 and/or 412 may provide a summary the status of such information and further detail may be provided regarding each category of information. The user interface 400 may also include an indication 414 of a category or status of the application. The indication 414 may indicate whether the application is approved, denied, requires further review, unreviewed, reviewed, or combination thereof (e.g., approved but unreviewed) by a third-party entity 132 when the passport data 124 is used in the context of an application.

The user interface 400 may also provide an approval summary 416. The approval summary 416 may include an income score 418, an expense score 420, a behavior score 422, and/or a composite score 424 (or financial score). As described previously, the scoring component 122 of the data verification system 106 may determine such scores. Each score may include an indication of the user's score out of a potential score. For example, with respect to the income score, the data verification system 106 determined that the user 102 scored 30 out of 35 potential points for the income category. However, these values are merely provided as examples and the scores may include any real number value. In some examples, the composite score 424 may include a recommendation of whether to approve the application. The recommendation may be presented to the third-party entity 132 and may indicate whether the data verification system 106 recommends approving an application or denying an application associated with the user 102.

In some examples, the user interface 400 may display one or more selectable controls 426 that, when selected, display additional information associated with a particular portion of the user interface 400 and the information associated therewith. For example, if a user 102 selects the selectable control 426 in the approval summary 416, the user interface 400 may display further information regarding the various calculated scores.

In some instances, the user interface 400 may display one or more income factors 428 determined by the scoring component. The one or more income factors 428 may be factors that impact an income and an income score of the user 102. In some examples, the scoring component may determine a score for each of factor. The scores of the individual factors may be added to determine the total score for a given category. In some examples, weighting the individual factors may include assigning a potential score to each of the factors. For example, a factor that is weighted heavier (e.g., net monthly income to rent with a potential score of 20) may be given a higher potential score than a factor that is weighted less (e.g., net passive income to rent with a potential score of 5). As mentioned previously, the weights may be assigned by the third-party entity 132 or the weights may be set automatically by the data verification system 106.

In some examples, the one or more income factors 428 may include various factors including, but not limited to, net monthly income to rent (or mortgage) (e.g., a comparison of net monthly income to a payment associated with the application such as a rental payment or mortgage payment), net passive income to rent, monthly debt payments to income, or other factors. Values of the one or more income factors 428 may be determined by the verification service and based at least in part on financial data and/or information received from an open banking system and/or from the user 102.

In some examples, the user interface 400 may display one or more expense factors 430. The one or more expense factors 430 may include factors that impact expenditure and an expense score of the user 102. Similar to the one or more income factors 428, the one or more expense factors 430 may be weighted and scored by the scoring component. The one or more expense factors 430 may include various factors including, but not limited to, free cash flow, balance trends, days in negative balance for accounts associated with the user, stop payment requests, past rent payments (if detected), weighted average of various expenses as a percentage of corresponding income score, among other expense factors. Values of the one or more expense factors 430 may be determined by the verification service and based at least in part on financial data and/or information received from an open banking system and/or from the user 102.

In some examples, the user interface 400 may display one or more behavior factors 432. The one or more behavior factors 432 may include factors that reflect a financial behavior of the user 102. Similar to the one or more income factors 428, the one or more behavior factors 432 may be weighted and scored by the scoring component. The one or more behavior factors 432 may include various factors including, but not limited to, non-sufficient funds (NSF) on day of income, any NSF instances, a balance trend for accounts associated with the user 102, among other behavior factors.

The user interface 400 may further provide a verification summary 434 indicating whether information associated with the user has been verified. The verification summary 434 may also display a summary of information that has been verified for various categories. For example, the verification summary 434 may include an income summary 436 representing an annual gross income associated with the user 102. As mentioned previously, the user interface 400 may display an icon 410 indicating that a category of information is unverified and/or unverifiable and may indicated to the third-party entity 132 that such a category requires further review. The verification summary 434 may include an indication 438 of whether the user currently pays for a rental or mortgage.

In some examples, upon selection of the selectable control 426 associated with the verification summary 434, the user interface may display additional information associated with the user and may provide an indication of whether the information is verified. For example, the verification summary 434 may display further information including, but not limited to, a full legal name of the user, a current address of the user, previous address(es) of the user, a yearly income of the user, current bank balance(s) of the user, monthly expenses of the user, monthly debt payments of the user, average monthly balance(s) of accounts associated with the user, among other potential information.

The user interface 400 may further provide a monthly income summary 440. The monthly income summary 440 may provide a summary of various categories of income associated with the user 102. For example, the monthly income summary 440 may include a payroll income category 442 which represents monthly income that the user 102 receives from a payroll associated with an employer. The monthly income summary 440 may also include an average monthly income category 444 which represents an average monthly income associated with the user 102. The monthly income summary 440 may also include an average government income category 446 which may represent an amount of income that the user 102 receives from the government. In some example, the government income category 446 may be included along with or replaced by an average passive income category which may represent an amount of income that the user 102 received from investments, properties, or other passive (or near passive) means.

The monthly income summary 440 may also include an average monthly closing balance 448 category which represents a closing balance of one or more accounts at an end of each data and divides the closing balance by a number of calendar days in a given month. The average monthly closing balance may be used to assess the user's income stability. In some examples, the average monthly closing balance may be calculated for individual accounts of the user or for accounts as a composite score. The monthly income summary 440 may also include a name 450 of an employer (e.g., ACME Co.) of the user 102. In some examples, upon selection of the selectable control 426 associated with the monthly income summary 440, the user interface 400 may display additional information associated with the monthly income of the user, provide graphics associated with the monthly income of the user, or other information and/or data.

The user interface 400 may further provide a debt analysis summary 452. The debt analysis summary 452 may provide a summary of various categories of debt associated with the user 102. For example, the debt analysis summary 452 may include an average monthly debt spending category 454 which represent an average monthly amount that the user 102 spends to pay various debts. The debt analysis summary 452 may also include a credit card debt category 456, mortgage(s) category 458, auto loans category 460, student loans 462 category, or other loans 464 category.

In some examples, upon selection of the selectable control 426 associated with the debt analysis summary 452, the user interface 400 may display additional information associated with debt of the user 102. For example, and with respect to the credit card debt category 456, the user interface 400 may display information such as a number of credit cards associated with the user, average payment amounts for the credit cards, an average monthly balance for the credit card. With respect to the mortgage(s) category 458, the user interface 400 may display information such as a number of mortgage(s) associated with the user, an average monthly payment amount, a number of missed payments within a predetermined time period, etc. Similar information may be determined and displayed via the user interface for other categories of the debt analysis summary 452.

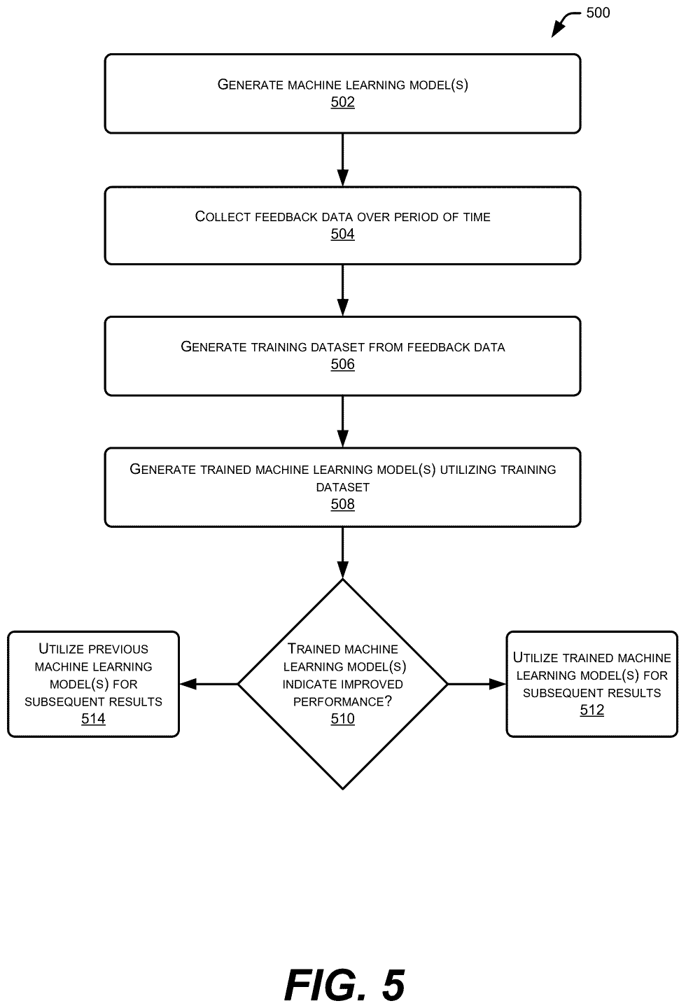

FIG. 5 illustrates example process for the generation of a machine-learning model and the use of the same. The order in which the operations or steps are described is not intended to be construed as a limitation, and any number of the described operations may be combined in any order and/or in parallel to implement process 500.

At block 502, the process 500 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence. Generating the one or more artificial intelligence models, such as a machine learning model, may further include collecting data in order to generate the one or more artificial intelligence models. The data may include any data described with respect to FIGS. 1-4, or any other data that may be used to perform the operations described herein.

At block 504, the process 500 may include collecting feedback data over a period of time. The feedback data may include any data described with respect to FIGS. 1-4, or any other data that may be used to perform the operations described herein.

At block 506, the process 500 may include generating a training dataset from the feedback data. Generation of the training dataset may include formatting the feedback data into input vectors for the artificial intelligence model to intake, as well as associating the various data with the produce category and/or produce subcategory as described herein.

At block 508, the process 500 may include generating one or more trained artificial intelligence models using the training dataset. Generation of the trained artificial intelligence models may include updating parameters and/or weightings and/or thresholds used by the models to determine ranked produce categories and/or subcategories predicting the identity of a produce item.

At block 510, the process 500 may include determining whether the trained artificial intelligence models indicate improved performance metrics. For example, a testing group may be generated where the produce categories and subcategories are known, but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 500 may include, at block 512, using the trained artificial intelligence models for generating subsequent results. For example, the trained artificial intelligence models may be used to calibrate confidence score thresholds and the like. It should be understood that the trained artificial intelligence models may be used in any scenario where models are used as described herein.

In examples where the trained artificial intelligence models do not indicate improved performance metrics, the process 500 may include, at block 514, using the previous iteration of the artificial intelligence models for generating subsequent results. Additionally, or alternatively, the process 500 may include, at block 514, reverting back to block 504 and collecting more feedback data over a period of time.

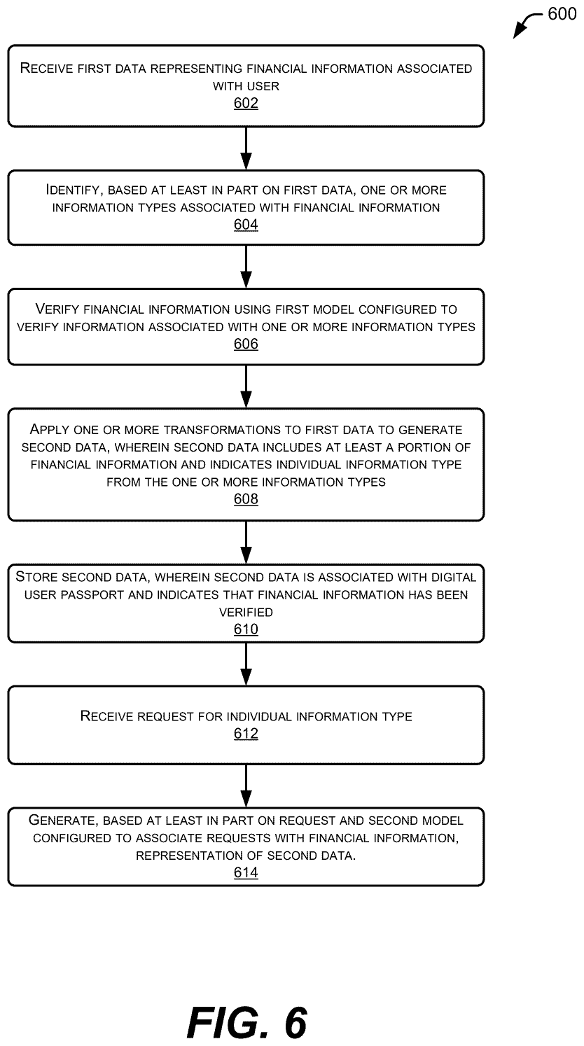

FIG. 6 illustrates an example method for verifying information and providing a recommendation with respect to an application. Various methods are described with reference to the example system of FIG. 1 and/or the user interfaces of FIGS. 2 and 3 for convenience and case of understanding. However, the methods described are not limited to being performed using the systems of FIG. 1 and/or the user interface of FIGS. 2 and 3, and may be implemented using systems and devices other than those described herein.

The techniques may be applied by a system comprising one or more processors, and one or more non-transitory computer-readable media storing computer-executable instructions that, when executed by the one or more processors, cause the one or more processors to perform operations of method 600.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the methods may be omitted entirely. Moreover, the methods described herein can be combined in whole or in part with one another, and/or with other methods.

At block 602, the method 600 may include receiving, at a data verification system, first data representing financial information associated with a user. For example, a user may be associated with a user device that enables the user to share user data with the verification service provider. In some examples, the user device(s) may include desktop computers, laptop computers, tablet computers, mobile devices (e.g., smart phones or other cellular or mobile phones, mobile gaming devices, portable media devices, etc.), or other suitable computing devices. The user device(s) may execute one or more client applications, such as a web browser (e.g., Microsoft Windows Internet Explorer, Mozilla Firefox, Apple Safari, Google Chrome, Opera, etc.) and/or a native or special-purpose client application (e.g., social media applications, messaging applications, email applications, games, etc.), to access and view content over the network.

In some instances, a user of the verification service provider may have user data that may be used in a transaction with third-party entities (e.g., lender, creditor, employer, etc.), such as applying for a lease, loan, or other type of contractual agreement. The user data may also represent the user's identification information. The data verification system may enable the user to share user data via an application installed on the user device and/or via a web-based application accessed via a web browser. For example, the data verification system may enable the user to upload image data associated with a financial document (e.g., driver's license, passport, bank statement, employment contract, lease agreement, etc.) via the application or the web-based application. Additionally, or alternatively, the data verification system may enable the user to complete a form to provide the user data via the application or the web-based application.

At block 604, the method 600 may include identifying, based at least in part on the first data, one or more information types associated with the financial information. For example, once the data verification system has received the user data from the user, the data verification system may include a passport generation component that is configured to identify the type, or category, of information included in the user data (e.g., income, identification, expenses, debt, etc.) and verify the information in order to generate passport data. The data verification system may include one or more servers or other computing devices, any or all of which may include one or more processors and memory storing computer executable instructions to implement the functionality discussed herein attributable to the data verification system or digital platform. The data verification system may enable users and/or third-party entities to interact with the data verification system.

At block 606, the method 600 may include verifying the financial information using a first model configured to verify information associated with the one or more information types. In some instances, such as when the user has uploaded image data associated with a financial document, where the user data is included in the financial document, the data verification system may be configured to verify the user data via verification component by identifying characteristics associated with such documents (i.e., serial numbers, water marks, etc.). In some examples, the verification component may be associated with machine-learning components, and may use optical character recognition, computer vision, and the like in order to verify the financial document, and in turn, verify the user data.

If the user provided user data including identification information by uploading a photograph of their government-issued ID card. The verification component may identify characteristics associated with the ID card (e.g., a mountain feature in the background of the ID card and license number) in order to verify the ID card as legitimate, and in turn verify the identifying user data. Additionally, or alternatively, the data verification system may send a prompt to the user to request access to user data from a third-party service that may provide at least a portion of the user data to the data verification system. For example, the data verification system may send a prompt to the user to authorize access to the user data by an open banking system, payroll data associated with an employer of the user, background check to be conducted via a background check service, credit check to be conducted via a credit check service, among other potential authorizations for third-party services. In some examples, the data verification system may send a prompt to the user to allow the user to select a third-party service provider that the user may have an account associated with. For example, to access payroll data associated with an employer, the user may log into a payroll service and may grant access to portion(s) of payroll data by the data verification system via the payroll service.

The verification component associated with the data verification system may verify user data received directly from the user and/or from the third-party service providers. In some instances, when the verification component determines that user data is consistent, the verification component may generate an indication that a portion of the user data has been verified. However, if the verification component determines that the user data is inconsistent, the verification component may generate an indication that a portion of the user data is unverified or requires further review or further information to verify the portion of the user data. Furthermore, if the verification component determines that user data is missing or incomplete, the verification component may generate an indication that the user data is missing or incomplete and may send a request to the user and/or the third-party service providers for additional information.

For example, the verification component may determine that a name of the user is consistent between an identification received from the user and financial information received from third-party service providers, such as an open banking system. Additionally, or alternatively, the verification component may also confirm that information is consistent with respect to current or past address(es), personal identification number(s), employment history, financial account information, debt information, etc. As such, the verification component may cross-check user data across various sources to determine whether such user data is consistent or not and may determine whether to verify such user data based on the consistencies or lack thereof.

At block 608, the method 600 may include applying one or more transformations to the first data to generate second data, wherein the second data includes at least a portion of the financial information and indicates an individual information type from the one or more information types. In some instances, after the user data from the user is validated, the data verification system may be configured to filter, or transform, the user data and associate the filtered data with the respective type of financial information. For example, a filtering component associated with the data verification system may filter, or transform, the user data and associate the filtered user data with the respective type of financial information. For example, the user may provide a document to the data verification system that includes various different types of information (e.g., a W-2 form may include identifying information such as SSN as well as income information). Additionally, or alternatively, the user data may include information that is not relevant to transactions involving the user and a third-party entity (e.g., it is not required for a lender, in deciding whether to grant a loan, to know that the user has green eyes as included in a government-issued ID). As such, the filtering component of the data verification system may “filter out” such information. In this way, the data verification system may generate filtered user data that may be associated with a specific type and/or category of financial information. In some examples, the filtered user data that may be associated with a specific type and/or category of financial information may be determined by a machine-learning component configured to filter and associate user data. The machine-learning component may be trained by determining one or more filters and/or or more types of financial information associated with the user data of a user over time. Furthermore, in some examples, the machine-learning component may be configured to automatically filter and/or associate user data with types of financial information by identifying patterns that may not be included in conventional financial documents or may not be easily recognized by a third-party entity. The filtered user data may then be stored as passport data in a digital passport or other type of representation that indicates that the user data has been verified.

At block 610, the method 600 may include storing the second data, wherein the second data is associated with a digital user passport and indicates that the financial information has been verified. After the user data has been verified by the verification component and/or filtered by the filtering component, and associated with, or added to, the user's digital passport as passport data, the passport data may be used to easily disseminate the user's financial information to third-party entities.

At block 612, the method 600 may include receiving a request for the individual information type. For example, third-party entities may submit a request for some, or all, of the user data. When the data verification system receives the request from a third-party entity for the user data, the request may include a request for one or more individual types of information (e.g., a request for verified income, a request for verified identification, a request for verified employment history, etc.). The data verification system may be configured to identify, or match, the one or more individual types of financial information included in the request with the passport data included in the digital passport that has been associated with at least one type of financial information. For example, the data verification system may be associated with a matching component that is configured to match the request with the appropriate passport data that is responsive to the request. Accordingly, the data verification system may provide to the third-party entity the passport data that has been matched to the one or more individual types of financial information included in the request. The matched passport data may be provided to the third-party entity by sharing a portion of and/or all of the digital passport. The passport data that is shared with the third-party entity may include actual user data (e.g., values associated with monthly income, DOB, list of employers, etc.) and/or include an indication that the user data has been verified.

The user may submit a request that their passport data be shared with a third-party entity in order to share their user data. For example, the user may be in the process of applying for a mortgage, and may request that their passport data be shared with a mortgage lender. A request may be associated with user account data, such as user browsing data, that is used to indicate a user's intent to share passport data. In some instances, when requests by the user and/or the third-party entity to share the passport data are received by the data verification system, the data verification system may allow the user to select which portion(s) of the passport data is to be shared and/or a duration of time to share the passport data. For example, when a third-party entity requests all types of user data, there may be some information that may be considered sensitive and/or not necessary for the third-party entity to obtain.

At block 614, the method 600 may include generating, based at least in part on the request and a second model configured to associate requests with the financial information, a representation of the second data. For example, the data verification system may allow the user to send passport data that indicates that their user data has been verified and/or provide a financial report and/or score without requiring sensitive information to be sent to the third-party entity. For example, once an identity of the user has been verified, the user may send, via the data verification system, passport data including an indication to a third-party entity that the identity of the user has been verified, but may choose to restrict access to personal and/or or sensitive user data (such as a SSN, DOB, or other information). As such, the third-party entity receives passport data including an indication that the identity of the user is verified, while such personal and/or sensitive user data is kept private by the user. Similarly, the user may choose to share a score associated with user data while choosing to restrict access to user data associated with income, expenses, or other financial data. As such, the third-party entity may receive an indication from the data verification system that the user has a score that satisfies one or more score thresholds, while keeping at least portion of the user data private. It is to be understood that the user is provided with complete control over which passport data is shared and which passport data the user desires to keep private. The user may also have complete control over permissions associated with the passport data that is shared with the third-party entity. Furthermore, the third-party entity may be provided with various controls for requesting which user data the third-party entity requires in order to be able to engage in a transaction with the user. The third-party entity may also be provided with various controls specifying a length of time for which a unique verification session is valid.

Additionally, or alternatively, the method 600 may include receiving a threshold associated with the financial information that is to be shared, storing the threshold with a block associated with the financial information, wherein the block is one of multiple blocks of a blockchain, and based at least in part on the threshold stored with the block, generating the representation of the second data in accordance with the threshold.

Additionally, or alternatively, the method 600 may include wherein the threshold includes at least one of, a quantity of the financial information that is to be shared, a threshold amount of time for sharing the financial information, or one or more individual information types associated with the financial information.

Additionally, or alternatively, the method 600 may include identifying a user browsing pattern, the user browsing pattern indicating a context associated with the individual information type, wherein, generating the representation of the second data is based at least in part on the context associated with the individual information type.

Additionally, or alternatively, the method 600 may further include, wherein the financial information associated with the user includes at least one of a time at which the financial information was received by the data verification system, an identity of the user, an income associated with the user, banking information associated with the user, employment history associated with the user, and/or rental history associated with the user.

Additionally, or alternatively, the method 600 may include, wherein the financial information is included in a document, identifying an indication included in the document of the user, wherein the indication at least partially includes verifying information associated with the financial information, and verifying the financial information associated with the user is based at least in part on the indication.

Additionally, or alternatively, the method 600 may further include, wherein the request is a first request, the portion of financial information is a first portion of financial information, and the individual information type is a first individual information type, based at least in part on the one or more transformations to the first data, generating third data, wherein the third data includes at least a second portion of the financial information and indicates a second individual information type from the one or more information types. The method 600 may also include storing the third data, wherein the third data is associated with the digital user passport and indicates that the financial information has been verified, receiving a second request for the second individual information type, and generating, based at least in part on the second request and the second model configured to associate the requests with the financial information, a representation of the third data.

What is claimed is:

1. A method comprising:
receiving, at a data verification system, first data representing financial information associated with a user;
identifying, based at least in part on the first data, one or more information types associated with the financial information;
verifying the financial information using a first model configured to verify information associated with the one or more information types;
applying one or more transformations to the first data to generate second data, wherein the second data includes at least a portion of the financial information and indicates an individual information type from the one or more information types;
storing the second data, wherein the second data is associated with a digital user passport and indicates that the financial information has been verified;
receiving a request for the individual information type; and
generating, based at least in part on the request and a second model configured to associate requests with the financial information, a representation of the second data.

2. The method of claim 1, further comprising:
receiving a threshold associated with the financial information that is to be shared;
storing the threshold with a block associated with the financial information, wherein the block is one of multiple blocks of a blockchain; and
based at least in part on the threshold stored with the block, generating the representation of the second data in accordance with the threshold.

3. The method of claim 2, wherein the threshold includes at least one of:
a quantity of the financial information that is to be shared;
a threshold amount of time for sharing the financial information; or
one or more individual information types associated with the financial information.

4. The method of claim 1, further comprising:
identifying a user browsing pattern, the user browsing pattern indicating a context associated with the individual information type, wherein,
generating the representation of the second data is based at least in part on the context associated with the individual information type.

5. The method of claim 1, wherein the financial information associated with the user includes at least one of:
a time at which the financial information was received by the data verification system;
an identity of the user;
an income associated with the user;
banking information associated with the user;
employment history associated with the user; or
rental history associated with the user.

6. The method of claim 1, wherein the financial information is included in a document, the method further comprising:
identifying an indication included in the document of the user, wherein the indication at least partially includes verifying information associated with the financial information; and
verifying the financial information associated with the user is based at least in part on the indication.

7. The method of claim 1, wherein the request is a first request, the portion of financial information is a first portion of financial information, and the individual information type is a first individual information type, the method further comprising:
based at least in part on the one or more transformations to the first data, generating third data, wherein the third data includes at least a second portion of the financial information and indicates a second individual information type from the one or more information types;
storing the third data, wherein the third data is associated with the digital user passport and indicates that the financial information has been verified;
receiving a second request for the second individual information type; and
generating, based at least in part on the second request and the second model configured to associate the requests with the financial information, a representation of the third data.

8. A system comprising:
one or more processors; and
one or more computer-readable media storing instructions that, when executed by the one or more processors, cause the one or more processors to perform operations comprising:
receiving, at a data verification system, first data representing financial information associated with a user;
identifying, based at least in part on the first data, one or more information types associated with the financial information;
verifying the financial information using a first model configured to verify information associated with the one or more information types;
applying one or more transformations to the first data to generate second data, wherein the second data includes at least a portion of the financial information and indicates an individual information type from the one or more information types;
storing the second data, wherein the second data is associated with a digital user passport and indicates that the financial information has been verified;
receiving a request for the individual information type; and
generating, based at least in part on the request and a second model configured to associate requests with the financial information, a representation of the second data.

9. The system of claim 8, the operations further comprising:
receiving a threshold associated with the financial information that is to be shared;
storing the threshold with a block associated with the financial information, wherein the block is one of multiple blocks of a blockchain; and
based at least in part on the threshold stored with the block, generating the representation of the second data in accordance with the threshold.

10. The system of claim 9, wherein the threshold includes at least one of:
a quantity of the financial information that is to be shared;
a threshold amount of time for sharing the financial information; or
one or more individual information types associated with the financial information.

11. The system of claim 8, the operations further comprising:
identifying a user browsing pattern, the user browsing pattern indicating a context associated with the individual information type, wherein,
generating the representation of the second data is based at least in part on the context associated with the individual information type.

12. The system of claim 8, wherein the financial information associated with the user includes at least one of:
a time at which the financial information was received by the data verification system;
an identity of the user;
an income associated with the user;
banking information associated with the user;
employment history associated with the user; or
rental history associated with the user.

13. The system of claim 8, wherein the financial information is included in a document, the operations further comprising:
identifying an indication included in the document of the user, wherein the indication at least partially includes verifying information associated with the financial information; and
verifying the financial information associated with the user is based at least in part on the indication.

14. The system of claim 8, wherein the request is a first request, the portion of financial information is a first portion of financial information, and the individual information type is a first individual information type, the operations further comprising:
based at least in part on the one or more transformations to the first data, generating third data, wherein the third data includes at least a second portion of the financial information and indicates a second individual information type from the one or more information types;
storing the third data, wherein the third data is associated with the digital user passport and indicates that the financial information has been verified;
receiving a second request for the second individual information type; and
generating, based at least in part on the second request and the second model configured to associate the requests with the financial information, a representation of the third data.

15. A non-transitory computer-readable medium storing having instructions stored thereon that, when executed by one or more processors, cause the one or more processors to perform operations comprising:
receiving, at a data verification system, first data representing financial information associated with a user;
identifying, based at least in part on the first data, one or more information types associated with the financial information;
verifying the financial information using a first model configured to verify information associated with the one or more information types;
applying one or more transformations to the first data to generate second data, wherein the second data includes at least a portion of the financial information and indicates an individual information type from the one or more information types;
storing the second data, wherein the second data is associated with a digital user passport and indicates that the financial information has been verified;
receiving a request for the individual information type; and
generating, based at least in part on the request and a second model configured to associate requests with the financial information, a representation of the second data.

16. The non-transitory computer-readable medium of claim 15, the operations further comprising:
receiving a threshold associated with the financial information that is to be shared;
storing the threshold with a block associated with the financial information, wherein the block is one of multiple blocks of a blockchain; and
based at least in part on the threshold stored with the block, generating the representation of the second data in accordance with the threshold.

17. The non-transitory computer-readable medium of claim 16, wherein the threshold includes at least one of:
a quantity of the financial information that is to be shared;
a threshold amount of time for sharing the financial information; or
an information type from the one or more information types associated with the financial information.

18. The non-transitory computer-readable medium of claim 15, the operations further comprising:
identifying a user browsing pattern, the user browsing pattern indicating a context associated with the individual information type, wherein,
generating the representation of the second data is based at least in part on the context associated with the individual information type.

19. The non-transitory computer-readable medium of claim 15, wherein the financial information is included in a document, the operations further comprising:
identifying an indication included in the document of the user, wherein the indication at least partially includes verifying information associated with the financial information; and
verifying the financial information associated with the user is based at least in part on the indication.

20. The non-transitory computer-readable medium of claim 15, wherein the request is a first request, the portion of financial information is a first portion of financial information, and the individual information type is a first individual information type, the operations further comprising:
based at least in part on the one or more transformations to the first data, generating third data, wherein the third data includes at least a second portion of the financial information and indicates a second individual information type from the one or more information types;
storing the third data, wherein the third data is associated with the digital user passport and indicates that the financial information has been verified;
receiving a second request for the second individual information type; and
generating, based at least in part on the second request and the second model configured to associate the requests with the financial information, a representation of the third data.
